(19) United States
(12) Patent Application Publication
(10) Pub. No.: US 2025/0298545 A1
(43) Pub. Date: Sep. 25, 2025

(54) DISTRIBUTING DEVICE, DISTRIBUTING SYSTEM, DISTRIBUTING METHOD AND PROGRAM

(71) Applicant: Nippon Telegraph and Telephone Corporation, Tokyo (JP)

(72) Inventors: Tetsuro TOKUNAGA, Musashino-shi, Tokyo (JP); Yoshihide NAKAGAWA, Musashino-shi, Tokyo (JP)

(21) Appl. No.: 18/869,333

(22) PCT Filed: Jun. 13, 2022
(86) PCT No.: PCT/JP2022/023616

§ 371 Date: Nov. 26, 2024

(51) Int. Cl. G06F 3/06

(52) U.S. Cl. CPC G06F 3/067; G06F 3/0604; G06F 3/0655

(57) ABSTRACT

A distribution device stores, in a storage unit, remaining capacity information of a protected area received from each of a plurality of host computers forming a computer cluster. Each time a processing request is received from one of the plurality of terminals, requesting execution of processing using an encrypted protected area on the memory of the host computer, the distribution device refers to the remaining capacity information of each of the plurality of host computers stored in the storage unit in accordance with the processing request to select a destination to which the processing request is to be distributed.

### TECHNICAL FIELD

The present invention relates to a distribution device, a distribution system, a distribution method, and a program.

### BACKGROUND ART

Conventionally, as a method for executing programs while protecting data, a function has been provided that creates an encrypted protected area (called an enclave) on memory and performs calculations using that protected area (for example, see NPL 1). Within the memory capacity of a computer, there is an upper limit to the capacity of a protected area that can be generated, depending on the type of a central processing unit (CPU). In other words, adding only memory to a computer does not increase the protected area capacity.

A program that uses protected areas uses protected areas and unprotected areas in memory. Since the protected area cannot be accessed even from the operating system (OS), it is not possible to perform paging processing from memory to storage, or to evacuate from memory to another computer and perform processing across multiple computers.

Computer cluster technology allows multiple computers to be interconnected via a network and controlled so that they can be treated as a single computer system. Conventionally, services have been provided that allow computers with encrypted protected areas on memory to be used as computer clusters via networks.

Existing load balancers can be used for computer clusters. A conventional load balancer periodically sends a request to check whether each computer under the load balancer is operating or not, and maintains information as to whether each computer is operating or not. When the load balancer receives a processing request from the terminal to the computer cluster via the network, the load balancer refers to the history of allocations to operating computers and allocates the processing to the first computer to which it was allocated. In this way, it is possible to allocate processing so that processing requests are not concentrated on specific computers (round-robin method).

There is also a method in which each computer under a load balancer determines whether or not to accept a processing request by itself, and transmits information indicating whether or not to accept the request to the load balancer. In this method, the load balancer can select computers under the load balancer and distribute processing based on the information (node determination method).

There is also a method in which a load balancer monitors the CPU usage rate and memory usage rate of each computer under the load balancer. In this method, the load balancer can select a computer with a low load at that time and distribute processing (resource monitoring method).

Additionally, if the load balancer receives processing requests from the same terminal consecutively within a certain period of time, the load balancer can allocate the next processing request from the terminal to the computer to which the processing request from the terminal has originally been allocated. In this way, it is possible for the load balancer to provide a consistent response to a processing group made up of multiple processing requests.

In this way, it is possible to configure a computer cluster and use multiple computers to handle processing requests even if the number of processing requests from terminals becomes too large to be processed by a single computer. Alternatively, even if processing is possible on one computer, a drop in response time and error responses can be prevented by processing on another computer.

### CITATION LIST

### Non Patent Literature

[NPL 1] “Enhanced Security Features for Confidential Computing”, Intel (registered trademark), [online], [searched on May 21, 2022], Internet <URL: https://cdrdv2.intel.com/v1/dl/getContent/723693>

### SUMMARY OF INVENTION

### Technical Problem

A computer cluster can be configured using a computer that is remote via a network and has an encrypted protected area on its memory, and a conventional load balancer. For example, when a person (an end user) other than the computer cluster provider attempts to provide a service that uses the computer cluster from a terminal, the following problems arise. In other words, in a usage method in which an end user accesses an API from a terminal and starts processing a program, including processing that uses a protected area, when the number of requests to start processing increases and multiple processes are started, there is a problem that depletion of the protected area can occur.

In detail, for example, when a round-robin type load balancer is used, various resources including the protected memory area of the computers may be depleted because it does not depend on the resource status of each computer in the computer cluster.

Furthermore, when a node determination type load balancer is used, since the protected area of the computer's memory is not considered in the logic for determining whether each computer in the computer cluster can accept the processing, the protected area may become depleted.

Furthermore, when a resource monitoring type load balancer is used, since the protected area of the computer's memory is not considered, the protected area may become depleted.

Therefore, with conventional load balancers, when processing that uses a protected area of a computer's memory is allocated, the computers in the computer cluster cannot process it due to the insufficient protected area, resulting in an increase in error responses from the computer cluster.

Therefore, an object of the present invention is to solve the above-mentioned problems and prevent an increase in error responses in a service that uses a computer cluster made up of computers having encrypted protected areas on memory.

### Solution to Problem

A distribution device according to the present invention includes a storage unit; an information creation unit that stores, in the storage unit, remaining capacity information of a protected area received from each of a plurality of host computers forming a computer cluster; a destination selection unit that, each time a processing request is received from one of a plurality of terminals, requesting execution of processing using an encrypted protected area on a memory of the host computer, refers to the remaining capacity information of each of the plurality of host computers stored in the storage unit in accordance with the processing request to select a destination to which the processing request is to be distributed; and a transfer processing unit that transfers the processing request to the destination and transfers a response according to the processing request received from the destination to a requesting terminal.

### Advantageous Effects of Invention

According to the present invention, it is possible to prevent an increase in error responses in a service that uses a computer cluster made up of computers having encrypted protected areas on memory.

### BRIEF DESCRIPTION OF DRAWINGS

FIG. 1 is a schematic configuration diagram of a distribution system according to the present embodiment.

FIG. 2A is a functional block diagram showing the configuration of a distribution device according to a first embodiment.

FIG. 2B is a table showing an example of the correspondence between communication destination information of a host computer and remaining capacity information of a protected area.

FIG. 2C is a table showing an example of the correspondence between communication destination information of a host computer and communication destination information of a terminal.

FIG. 3 is a sequence diagram illustrating processing of storing encrypted remaining capacity information of a protected area on a memory.

FIG. 4 is a sequence diagram showing an example of the operation of the distribution device according to the first embodiment.

FIG. 5 is a diagram illustrating an example of message content of a processing request for requesting protected area usage processing.

FIG. 6 is a sequence diagram showing an example of the operation of a distribution device according to a second embodiment.

FIG. 7 is a sequence diagram showing an example of the operation of a distribution device according to a third embodiment.

FIG. 8 is a sequence diagram showing an example of the operation of a distribution device according to a fourth embodiment.

FIG. 9A is a functional block diagram showing the configuration of a distribution device according to a fifth embodiment.

FIG. 9B is a table showing an example of the correspondence between communication destination information of a host computer and remaining capacity information of a protected area.

FIG. 9C is a table showing an example of the correspondence between communication destination information of a host computer and communication destination information of a terminal.

FIG. 10 is a sequence diagram showing an example of the operation of the distribution device according to the fifth embodiment.

FIG. 11 is a functional block diagram showing the configuration of a distribution device according to a sixth embodiment.

FIG. 12A is a table showing an example of the correspondence between communication destination information of a host computer and remaining capacity information of a protected area.

FIG. 12B is a table showing an example of the correspondence between communication destination information of a host computer and communication destination information of a terminal.

FIG. 13A is a table showing an example of the correspondence between communication destination information of a host computer and remaining capacity information of a protected area.

FIG. 13B is a table showing an example of the correspondence between communication destination information of a host computer and remaining capacity information of a protected area.

FIG. 14A is a functional block diagram showing the configuration of a distribution device according to a ninth embodiment.

FIG. 14B is a schematic diagram of a queue.

FIG. 15 is a sequence diagram showing an example of the operation of a distribution device according to a ninth embodiment.

FIG. 16 is a hardware configuration diagram showing an example of a computer that implements the functions of the distribution device according to the present embodiment.

### DESCRIPTION OF EMBODIMENTS

Hereinafter, the distribution device according to the present embodiment will be described in detail with reference to the drawings.

### Outline of System Configuration

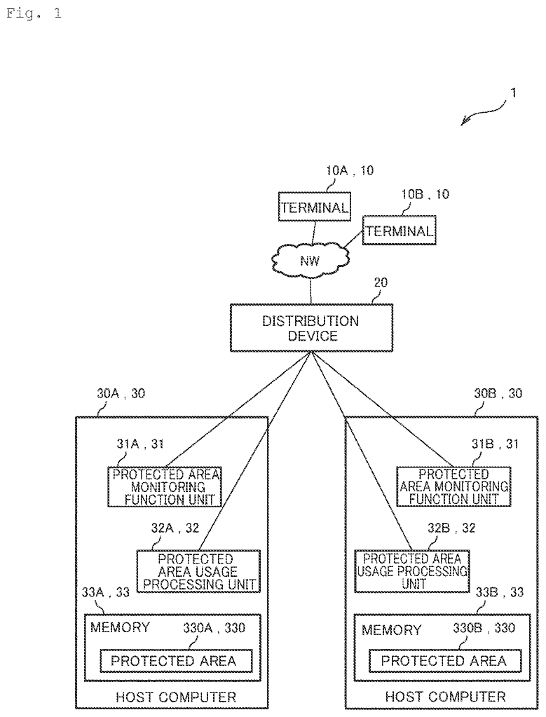

A distribution system 1 shown in FIG. 1 distributes processing requests sent from a plurality of terminals 10. The distribution system 1 includes a distribution device 20 and a plurality of host computers 30 (hereinafter referred to as hosts 30) forming a computer cluster. The host 30 includes an encrypted protected area 330 on a memory 33. The protected area 330 is an area of the memory 33 that has different characteristics from other areas, and is an area where a part of the memory 33 is encrypted to protect data. The protected area 330 cannot be accessed by other processes including the OS (it is not meaningful even if it is accessed). Hereinafter, a processing request refers to a request signal requesting execution of processing (also referred to as protected area usage processing) that uses the encrypted protected area 330 on the memory 33 of one of the hosts 30.

The distribution device 20 receives information on the remaining capacity of the protected area 330 from the plurality of hosts 30, and stores the remaining capacity information in a storage unit in an updatable manner. Upon receiving a processing request, the distribution device 20 refers to the stored remaining capacity information of the protected area and allocates the processing request to a predetermined host 30 based on the remaining capacity information so that the protected area within the computer cluster does not become depleted.

Here, “distributing” means that the distribution device 20 allocates a plurality of processing requests, such as a processing request received for the first time and a processing request received next, to different hosts 30 from the viewpoint of focusing on multiple processing requests on the terminal 10 side.

In addition, “allocating” means that for example, the distribution device 20 selects and determines the host 30 to which one processing request should be transferred among a plurality of hosts 30 from the viewpoint of focusing on a plurality of hosts 30 side.

Note that when the distribution device 20 receives processing requests from the same terminal 10 consecutively within a certain period of time, the distribution device 20 can allocate the next processing request from the corresponding terminal 10 to the host 30 to which the processing request from the corresponding terminal 10 was initially allocated.

### First Embodiment

### Details of System Configuration

As shown in FIG. 1, the computer cluster includes, for example, two hosts 30A and 30B. The host 30A includes a protected area monitoring function unit 31A, the protected area usage processing unit 32A, and a memory 33A, and the memory 33A includes an encrypted protected area 330A. The host 30B includes a protected area monitoring function unit 31B, the protected area usage processing unit 32B, and a memory 33B, and the memory 33B includes an encrypted protected area 330B. In the following, when the two devices are not distinguished, they will be referred to as a host 30, a protected area monitoring function unit 31, the protected area usage processing unit 32, a memory 33, and a protected area 330. Note that the number of hosts 30 is just an example, and is not limited to two.

In the host 30, the protected area monitoring function unit 31 acquires the remaining capacity information of the protected area 330, and notifies the distribution device 20 of the remaining capacity information together with the communication destination information of the host 30. In the present embodiment, the protected area monitoring function unit 31 acquires the remaining capacity information by, for example, periodically inquiring about the remaining capacity information of the protected area 330 from the protected area usage processing unit 32.

Upon receiving a processing request from the distribution device 20, the protected area usage processing unit 32 executes the protected area usage processing and transmits a response including a return value according to the protected area usage processing to the distribution device 20. The protected area usage processing is some type of processing performed using the protected area 330 of the memory 33. The content of the protected area usage processing include, for example, processing that uses the protected area 330 of the memory 33 to handle personal information, finance-related processing, and the like.

A terminal 10A and a terminal 10B are connected to the distribution device 20 via a network NW. Below, if the two terminals are not distinguished, they will refer to them as a terminal 10. The terminal 10 is the requester of the processing request, and is, for example, a personal computer, a mobile terminal, a tablet terminal, or the like. The terminal 10 is used by someone (an end user) other than the computer cluster provider. Note that the number of terminals 10 is just an example, and is not limited to two.

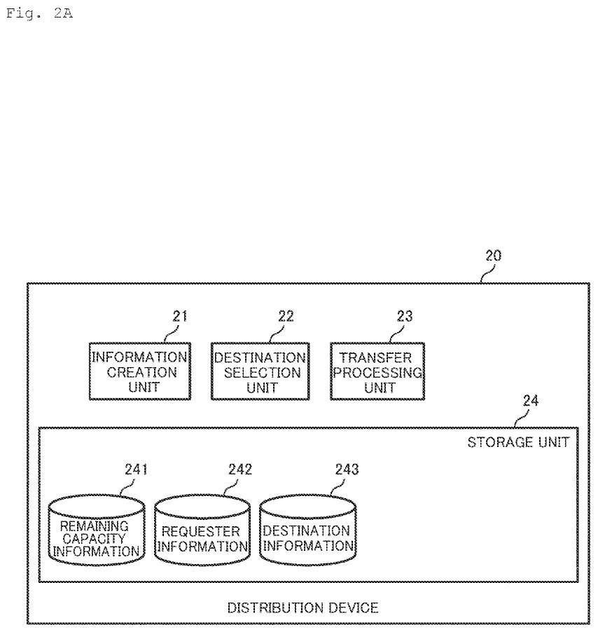

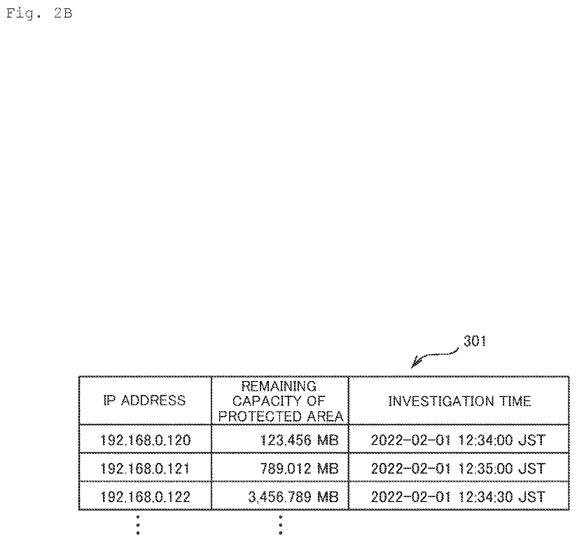

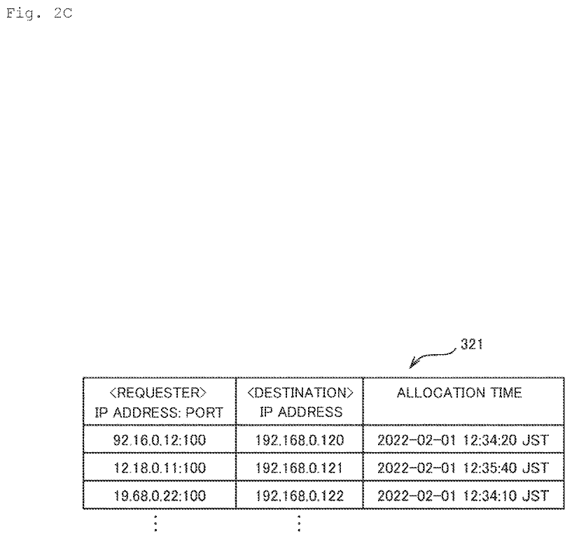

FIG. 2A is a functional block diagram showing the configuration of the distribution device according to the first embodiment.

The distribution device 20 includes an information creation unit 21, a destination selection unit 22, a transfer processing unit 23, and a storage unit 24.

The information creation unit 21 stores, in the storage unit 24, the remaining capacity information of the protected area 330 received from each of the plurality of hosts 30 forming the computer cluster.

Each time the destination selection unit 22 receives a processing request from one of the plurality of terminals 10 requesting execution of processing using the encrypted protected area 330 on the memory 33 of the host 30, the destination selection unit 22 refers to the remaining capacity information of each of the plurality of hosts 30 stored in the storage unit 24 in response to the processing request and selects a destination to which the processing request is to be distributed.

The transfer processing unit 23 transfers the processing request to the destination, and also transfers a response according to the processing request received from the destination to the requesting terminal 10.

In the present embodiment, the information creation unit 21 stores communication destination information of the host 30 together with the remaining capacity information of the protected area 330 in the storage unit 24. The destination selection unit 22 stores, in the storage unit 24, the communication destination information of the terminal 10 that has requested the processing request together with the communication destination information of the destination to which the processing request is to be distributed.

The storage unit 24 stores remaining capacity information 241, requester information 242, and destination information 243, as shown in FIG. 2A. The remaining capacity information 241 schematically shows the remaining capacity information of the protected area 330 at a certain point in time, which is collected from each of the plurality of hosts 30 forming the computer cluster. The requester information 242 schematically shows the communication destination information of each terminal 10 that sent the processing request. The destination information 243 schematically shows the communication destination information of each host 30 to which a processing request is allocated. Note that the storage unit 24 may store information such as the total capacity of the protected area 330 of each host 30 forming the computer cluster.

As shown in FIG. 2B, the storage unit 24 stores the correspondence information 301 between the communication destination information of each host 30 forming the computer cluster and the remaining capacity information of the protected area 330 of the memory 33 of the host 30 in an updatable manner. The correspondence information 301 has an IP address and a remaining capacity of the protected area as table items. Here, the IP address serves as both an identifier and a communication destination of the host 30 that has notified of the remaining capacity of the protected area.

In addition, when the protected area monitoring function unit 31 notifies the distribution device 20 of the remaining capacity information of the protected area 330 and the time (investigation time) when the remaining capacity was acquired, the investigation time is stored in the correspondence information 301. Note that the distribution device 20 may store the time (acquisition time) when the remaining capacity information was received from the host 30, or may store both the investigation time and the acquisition time.

As shown in FIG. 2C, the storage unit 24 stores the correspondence information 321 between the communication destination information of each of the terminals 10 that sent the processing request and the communication destination information of each of the hosts 30 to which the processing request is allocated in an updatable manner. The correspondence information 321 has requester information and destination information as table items. Here, the requester information is the IP address and port of the terminal 10 that sent the processing request. In this way, the consistency of the terminal 10 can be maintained.

The destination information is the IP address of the host 30 to which the processing request is allocated.

The data structure of the correspondence information 301 and the correspondence information 321 is not limited to the illustrated column structure. The data structure of the correspondence information 301, 321 may not be a relational database (RDB). The correspondence information 301 and the correspondence information 321 may be merged and managed using the destination in the correspondence information 321 as a key.

### Operation of Distribution System

Next, the operation of the distribution system will be explained.

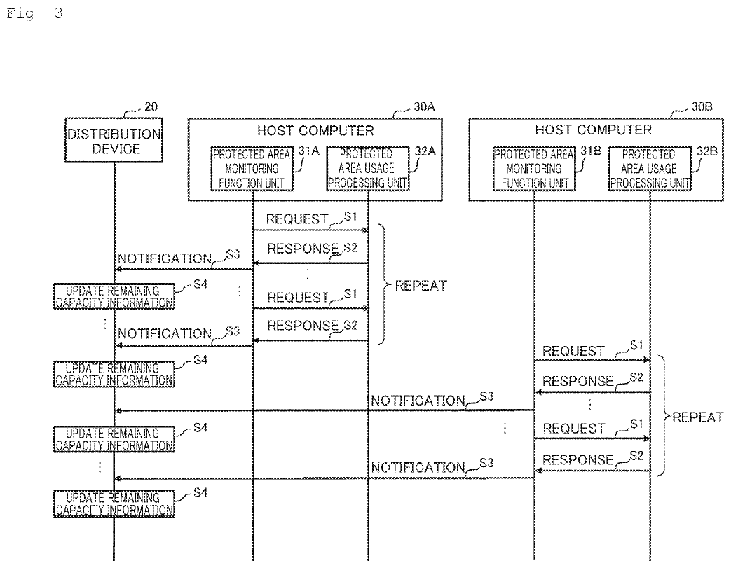

First, with reference to FIG. 3 (see FIG. 1 as appropriate), the flow of collecting the remaining capacity information of the protected area 330 of the memory 33 in the computer cluster will be described.

In each of the hosts 30A and 30B, the protected area monitoring function units 31A and 31B request the protected area usage processing units 32A and 32B to acquire the remaining capacity information of the protected areas 330A and 330B in the memories 33A and 33B (step S1). The protected area usage processing units 32A and 32B output the remaining capacity information in response to the acquisition request (step S2). Then, the hosts 30A and 30B notify the distribution device 20 of the remaining capacity information acquired by the protected area monitoring function units 31A and 31B and the transmission destination to the hosts 30A and 30B (step S3).

Then, the distribution device 20 stores the remaining capacity information of the protected area 330 received from the hosts 30A and 30B in the storage unit 24 (step S4). If the information of the corresponding host 30 has already been stored, the distribution device 20 updates the information. Note that the protected area monitoring function units 31A and 31B of the hosts 30A and 30B may also notify the distribution device 20 of the time (investigation time) at which the remaining capacity of the protected areas 330A and 330B was acquired. In this case, the distribution device 20 may also store and update the received investigation time.

The trigger for the protected area monitoring function units 31A and 31B to acquire the remaining capacity information of the protected areas 330A and 330B in the memories 33A and 33B and the trigger for notifying the distribution device 20 of the remaining capacity information may be set as a time interval or a time in advance, for example. Alternatively, upon receiving an instruction from the distribution device 20, the remaining capacity information may be acquired or the remaining capacity information may be notified to the distribution device 20. In the present embodiment, as an example, it is assumed that the operation is performed periodically according to the settings.

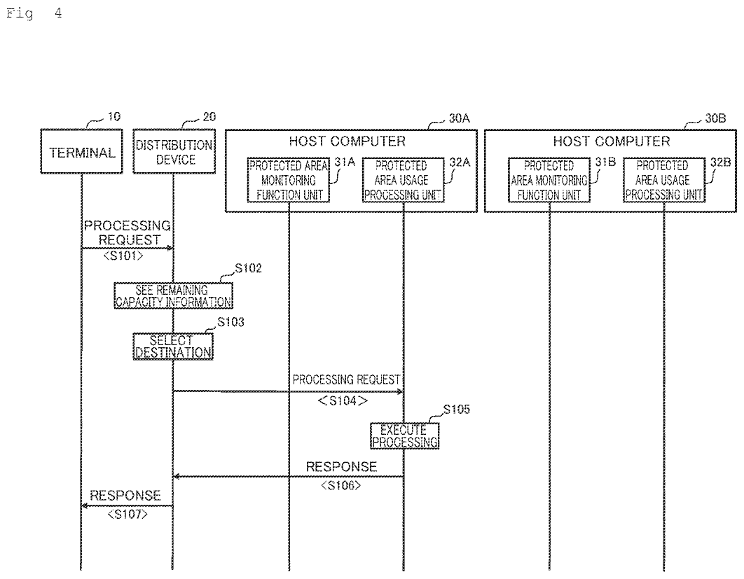

Next, the flow of processing for allocating processing requests will be described with reference to FIG. 4 (see FIGS. 1 and 2A as appropriate). First, one of the plurality of terminals 10 transmits a processing request to the distribution device 20 requesting execution of protected area usage processing (step S101), and the distribution device 20 receives the processing request from the terminal 10.

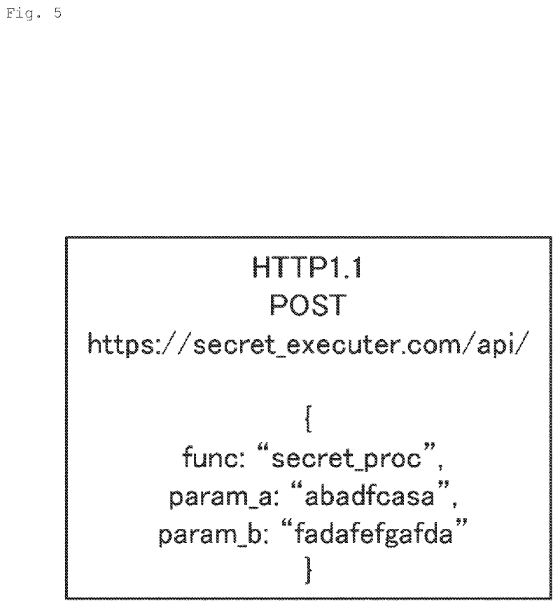

FIG. 5 is an example of message content of a processing request. The processing request includes parameters corresponding to the content of the protected area usage processing. Note that various message protocols and remote procedure protocols, such as gRPC (Google (registered trademark) Remote Procedure Call), REST API (REST Application Programming Interface), and XML-RPC (Extensible Markup Language-Remote Procedure Call), which are existing technologies, can be used to transmit processing requests.

Each time the distribution device 20 receives a processing request, the distribution device 20 refers to the remaining capacity information of each of the plurality of hosts 30 stored in the storage unit 24 in accordance with the processing request (step S102). Here, the destination selection unit 22 refers to the correspondence information 301 (FIG. 2B), for example. Then, the destination selection unit 22 selects, for example, the host 30 with a large remaining capacity of the protected area 330 as the destination to which the processing request is distributed (step S103). Then, in the distribution device 20, the transfer processing unit 23 transfers the processing request to the IP address selected as the destination (step S104).

Note that when processing requests from the same requester are received consecutively within a certain period of time, the distribution device 20 allocates the next processing request from the same requester to the host 30 to which the processing request was initially allocated. The same requester refers to the terminals 10 with the same IP address and port.

Each time the distribution device 20 receives a processing request, the distribution device 20 stores the IP address and port of the requester, the IP address of the allocated destination, and the allocation time (time at which the processing request was transferred). As a result, the correspondence information 321 (FIG. 2C), for example, is created in the storage unit 24. For example, when information about the same requester is stored in the correspondence information 321, the distribution device 20 updates the time information. The corresponding data may be deleted after a certain period of time (for example, 24 hours) has passed since the allocation time.

In step S104, when the distribution device 20 transfers the processing request to the host 30A, the protected area usage processing unit 32A of the host 30A executes the protected area usage processing according to the processing request (step S105). Upon finishing the processing, the protected area usage processing unit 32A of the host 30A sends a response including a return value according to the processing to the distribution device 20 (step S106). The distribution device 20 receives a response including a return value according to the processing from the host 30A.

Then, the distribution device 20 transfers the response received from the host 30A to the requesting terminal 10 (step S107). At this time, the distribution device 20 transfers the response to the requesting terminal 10 based on the correspondence information 321 (FIG. 2C) between the requester IP address and the destination IP address.

### Second Embodiment

The second embodiment is used when the safety of the communication path between a terminal and a distribution device cannot be guaranteed. The distribution device according to the second embodiment differs from the distribution device 20 shown in FIG. 2A in that it encrypts data transmitted to and received from terminals. The preparation processing, encryption processing, and decryption processing of encrypted communication may be implemented inside the terminal or the distribution device, or may be implemented and used as separate functions.

The configuration of the distribution device (hereinafter referred to as distribution device 20B) according to the second embodiment is the same as the configuration of the distribution device 20 except that it has an existing configuration required for encrypted communication, so the explanation of the drawings and configuration will be omitted.

Next, the operation of the distribution system according to the second embodiment will be explained. Note that the same elements as in the configuration (or process) shown in FIGS. 1, 2A, 3, and 4 are designated by the same reference numerals, and the explanation thereof will be omitted as appropriate. First, the flow of collecting the remaining capacity information of the protected area 330 of the memory 33 in the computer cluster is the same as the process shown in FIG. 3, so the explanation will be omitted.

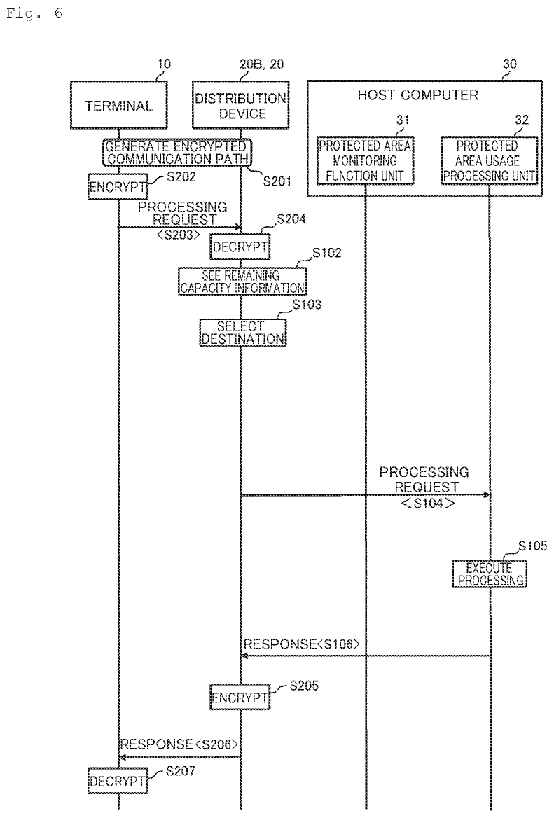

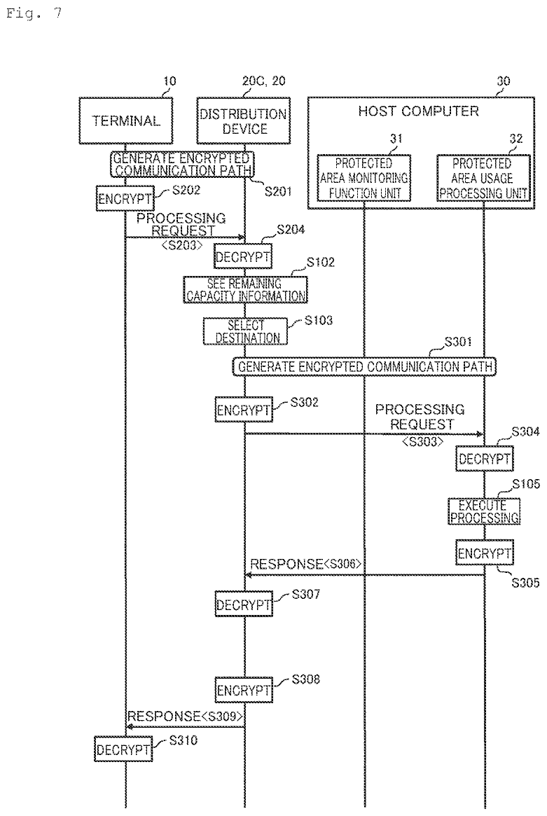

Next, the flow of processing in which the distribution device 20B allocates processing requests will be described with reference to FIG. 6 (see FIGS. 1, 2A, and 4 as appropriate). Note that FIG. 6 and FIGS. 7, 8, 10, and 15, which will be described later, show only one host 30 that is a destination, and illustrations of hosts that are not destinations are omitted. Further, processes that are the same as those shown in FIG. 4 are designated by the same reference numerals, and the explanation thereof will be omitted.

First, before the terminal 10 sends a processing request to the distribution device 20B, the terminal 10 and the distribution device 20B perform negotiation to generate an encrypted communication path (step S201). At this time, it is preferable to use the existing secure socket layer (SSL) negotiation technology. In this case, the terminal 10 acts as a client, the distribution device 20B acts as a server, and certificate verification or the like is performed to generate a session key (hereinafter referred to as session key A) that is a common key. Further, the distribution device 20B stores the session key A in association with the requester IP address.

Next, the terminal 10 encrypts the content of the processing request with the session key A (step S202), and transmits the encrypted processing request to the distribution device 20B (step S203). Then, the distribution device 20B receives the encrypted processing request. The distribution device 20B decrypts the content of the encrypted processing request using the session key A (step S204). In this way, it is possible for the distribution device 20B to grasp the content of the received processing request.

Subsequently, the processes from step S102 to step S106 shown in FIG. 6 are the same as the processes shown in FIG. 4, so the explanation thereof will be omitted. Note that when the distribution device 20B selects the destination to which the processing request is to be distributed in step S103, the distribution device 20B associates the allocated destination IP address with the requester IP address, so that the destination IP address and the session key A can be associated in the storage unit 24.

Following step S106, the distribution device 20B receives a response including a return value according to the processing from the host 30 that executed the protected area usage processing. In order to transfer the response to the requesting terminal 10, the distribution device 20B refers to the correspondence information 321 (FIG. 2C) between the requester IP address and the destination IP address. At this time, the distribution device 20B encrypts the return value using the session key A associated with the requester IP address (step S205). Then, the distribution device 20B transfers the encrypted response to the requesting terminal 10 (step S206). The requesting terminal 10 decrypts the received information using the session key A (step S207) and can acquire a response to the processing request.

### Third Embodiment

The third embodiment is used when the safety of a communication path between a terminal and a distribution device and a communication path between a distribution device and the protected area usage processing unit of a host cannot be guaranteed. The distribution device according to the third embodiment differs from the distribution device 20B according to the second embodiment in that it encrypts data transmitted to and received from the protected area usage processing unit. The preparation processing, encryption processing, and decryption processing of encrypted communication may be implemented inside the terminal, the distribution device, or the protected area usage processing unit of the host, or may be implemented and used as separate functions.

The configuration of the distribution device (hereinafter referred to as distribution device 20C) according to the third embodiment is the same as the configuration of distribution device 20 except that it has an existing configuration required for encrypted communication, so the explanation of the drawings and configuration will be omitted.

Next, the operation of the distribution system according to the third embodiment will be explained. Note that the same elements as in the configuration (or process) shown in FIGS. 1, 2A, 3, 4, and 6 are designated by the same reference numerals, and the explanation thereof will be omitted as appropriate.

First, the flow of collecting the remaining capacity information of the protected area 330 of the memory 33 in the computer cluster is the same as the process shown in FIG. 3, so the explanation will be omitted.

Next, the flow of processing in which the distribution device 20C allocates processing requests will be described with reference to FIG. 7 (see FIGS. 1, 2A, 4, 6 as appropriate). Each process from step S201 to step S204 and step S102 to step S103 shown in FIG. 7 are the same as the processes shown in FIG. 6, so the explanation thereof will be omitted.

Following step S103, before the distribution device 20C sends a processing request to the destination IP address, the distribution device 20C and the protected area usage processing unit 32 of the destination host 30 perform negotiation to generate an encrypted communication path (step S301). At this time, it is preferable to use SSL negotiation. In this case, the distribution device 20C acts as a client, the protected area usage processing unit 32 acts as a server, and certificate verification or the like is performed to generate a session key (hereinafter referred to as session key B) that is a common key. Further, the distribution device 20C stores the session key B in association with the IP address of the destination host 30.

Next, the distribution device 20C encrypts the content of the processing request using the session key B (step S302), and transmits the encrypted processing request to the protected area usage processing unit 32, which is the destination (step S303). The protected area usage processing unit 32 receives the encrypted processing request. Then, the protected area usage processing unit 32 decrypts the content of the received processing request using the session key B (step S304). In this way, the protected area usage processing unit 32 grasps the content of the received processing request and executes the protected area use processing according to the processing request (step S105). Upon finishing the processing, the protected area usage processing unit 32 encrypts a response including a return value according to the processing using the session key B (step S305), and sends it to the distribution device 20C (step S306). The distribution device 20C receives the encrypted response from the protected area usage processing unit 32 of the host 30.

Then, the distribution device 20C decrypts the encrypted response using the session key B stored in association with the IP address of the host 30 (step S307), and acquires a response including the return value. Then, the distribution device 20C refers to the correspondence information 321 (FIG. 2C) between the requester IP address and the destination IP address, and identifies the requesting terminal 10. At this time, the distribution device 20C encrypts the return value using the session key A associated with the requester IP address (step S308). Then, the distribution device 20C transfers the encrypted response to the requesting terminal 10 (step S309). The requesting terminal 10 decrypts the received information using the session key A (step S310) and can acquire a response to the processing request.

### Fourth Embodiment

In the fourth embodiment, before sending a processing request from a terminal to a distribution device, capacity information required for protected area usage processing is transmitted. The distribution device according to the fourth embodiment differs from the distribution device 20B according to the second embodiment in that it determines the availability of a host according to required capacity information and notifies the terminal of the determination result. The preparation processing, encryption processing, and decryption processing of encrypted communication may be implemented inside the terminal or the distribution device, or may be implemented and used as separate functions.

The configuration of the distribution device according to the fourth embodiment (hereinafter referred to as distribution device 20D) is the same as the configuration of the distribution device 20, except that it determines the availability of a host according to required capacity information, so the explanation of the drawings and configuration will be omitted.

Next, the operation of the distribution system according to the fourth embodiment will be explained. Note that the same elements as in the configuration (or process) shown in FIGS. 1, 2A, 3, 4, and 6 are designated by the same reference numerals, and the explanation thereof will be omitted as appropriate.

First, the flow of collecting the remaining capacity information of the protected area 330 of the memory 33 in the computer cluster is the same as the process shown in FIG. 3, so the explanation will be omitted.

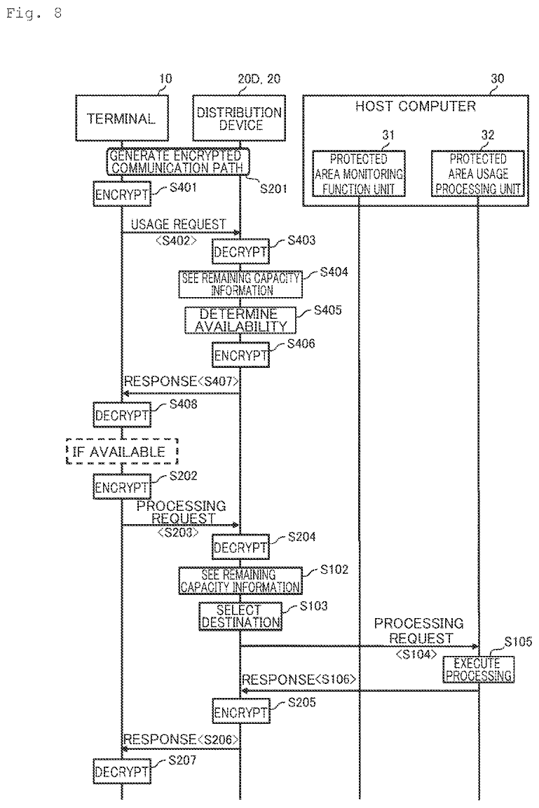

Next, the flow of processing when sending a usage request before sending a processing request from the terminal 10 to the distribution device 20D will be described with reference to FIG. 8 (see FIGS. 1, 2A, 4, and 6 as appropriate). The usage request means a request signal that includes capacity information of the protected area required for the protected area usage processing and requests confirmation whether or not the protected area usage processing is available.

The process of step S201 shown in FIG. 8 is the same as the process shown in FIG. 6, so the explanation will be omitted. Following step S201, the terminal 10 encrypts the content of the usage request using the session key A (step S401). Then, the terminal 10 transmits the encrypted usage request to the distribution device 20D (step S402). Note that gRPC, REST API, XML-RPC, or the like may be used as a method for transmitting usage requests.

Then, the distribution device 20D decrypts the content of the encrypted usage request using the session key A (step S403). In this way, the distribution device 20B can grasp that the content of the received encrypted data is the capacity information and availability confirmation of the necessary protected area. In response to the usage request, the distribution device 20D refers to the remaining capacity information of each of the plurality of hosts 30 stored in the storage unit 24 (step S404). Here, the destination selection unit 22 refers to the correspondence information 301 (FIG. 2B), for example, and determines availability based on the remaining capacity information (step S405).

If there is a host that can store the capacity required for the protected area usage processing, the distribution device 20D creates a response indicating that it is available. On the other hand, if there is no host that can store the required capacity, the distribution device 20D creates a response indicating that the capacity is unavailable. Then, the distribution device 20D encrypts the content of the response using the session key A (step S406), and transmits the encrypted response to the terminal 10 (step S407). The requesting terminal 10 receives the encrypted response. Then, the terminal 10 decrypts the content of the response using the session key A (step S408), and can acquire a response to the usage request.

If the protected area usage processing is available, the flow of the processing in which the distribution device 20D subsequently allocates a processing request is the same as the operation of the distribution device 20B of the second embodiment. That is, the processes of steps S202 to S204, S102 to S106, and S205 to S207 shown in FIG. 8 are the same as the processes shown in FIG. 6, so the explanation in this case will be omitted.

Note that if the communication path between the terminal 10 and the distribution device 20D is secure, it may be implemented without encryption as in the first embodiment. Further, as in the third embodiment, communication between the distribution device 20D and the protected area usage processing unit 32 may be encrypted.

### Fifth Embodiment

In the fifth embodiment, before sending a processing request from a terminal to a distribution device, capacity information required for protected area usage processing is transmitted, and if available, reservation is made at that time. Therefore, the distribution device according to the fifth embodiment differs from the distribution device 20D according to the fourth embodiment in that it reserves the use of a host according to required capacity information. The preparation processing, encryption processing, and decryption processing of encrypted communication may be implemented inside the terminal or the distribution device, or may be implemented and used as separate functions.

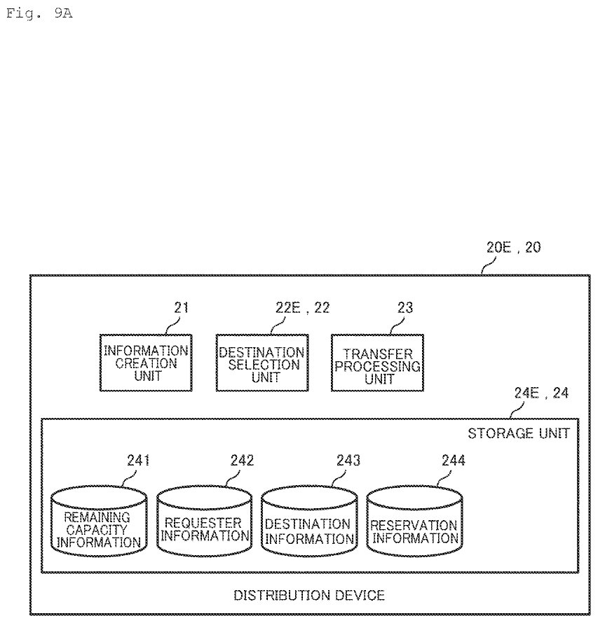

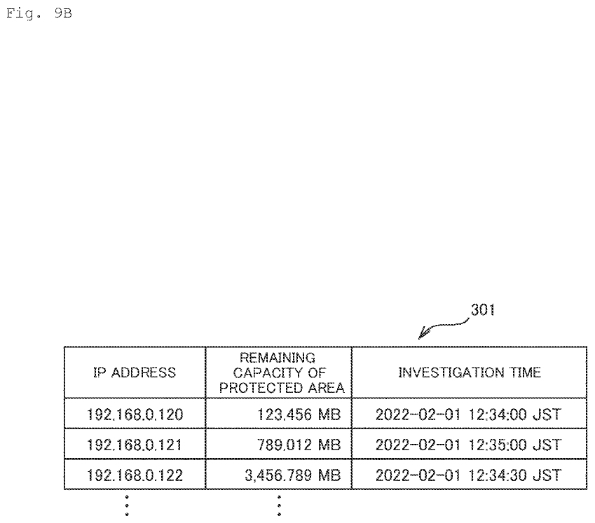

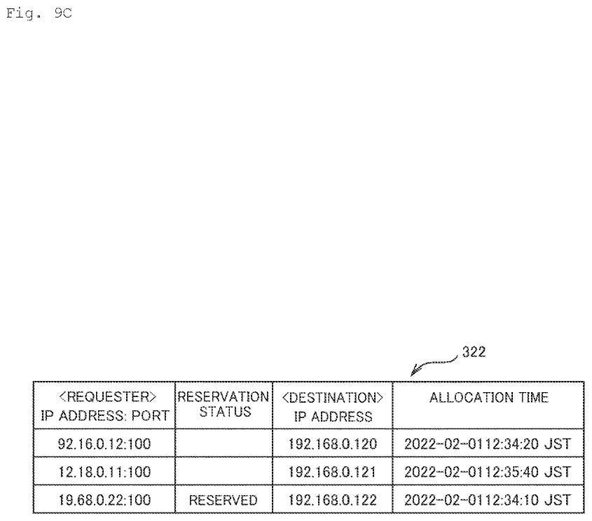

As shown in FIG. 9A, the distribution device 20E according to the fifth embodiment includes an information creation unit 21, a destination selection unit 22E, a transfer processing unit 23, and a storage unit 24E. Note that the same elements as in the configuration shown in FIG. 2A are designated by the same reference numerals, and the explanation thereof will be omitted, and the differences from the distribution device 20 shown in FIG. 2A will be explained.

The destination selection unit 22E is similar to the destination selection unit 22 shown in FIG. 2A in that it selects the host 30 with a large remaining capacity of the stored protected area 330 as the destination to which the processing request is distributed. However, the destination selection unit 22E differs from the destination selection unit 22 shown in FIG. 2A in that it rewrites the remaining capacity information stored for the reserved host 30.

Specifically, the destination selection unit 22E can receive a reservation request from the terminal 10 before the processing request. A reservation request means a request signal that includes capacity information of a protected area required for the protected area usage processing and requests reservation of the protected area usage processing.

When a reservation request is received and it is determined that the protected area usage processing is available, the destination selection unit 22E subtracts the capacity information required for the protected area usage processing from the remaining capacity information stored for the host 30 determined to be available and rewrite the stored remaining capacity information.

The storage unit 24E stores remaining capacity information 241, requester information 242, destination information 243, and reservation information 244, as shown in FIG. 9A. The reservation information 244 schematically shows information indicating whether or not the host 30 is reserved. Furthermore, the storage unit 24E stores correspondence information 301 shown in FIG. 9B in an updatable manner. This correspondence information 301 is similar to the correspondence information 301 shown in FIG. 2B.

As shown in FIG. 9C, the storage unit 24E stores the correspondence information 322 between the communication destination information of the terminal 10 that sent the reservation request and the communication destination information of the reserved host 30 in an updatable manner. Here, the correspondence information 322 also serves as correspondence information 321 (see FIG. 2C) between the communication destination information of the terminal 10 that sent the processing request and the communication destination information of the host 30 to which the processing request is allocated.

The correspondence information 322 includes requester information, reservation status, and destination information as table items. Here, the requester information is the IP address and port of the terminal 10 that sent the reservation request. The reservation status indicates, for example, whether the host is reserved. The destination information is the IP address of the reserved host 30. Note that a record with a status of reservation may be deleted after a certain period of time has elapsed.

The data structure of the correspondence information 301 and the correspondence information 322 is not limited to the illustrated column structure. The data structure of the correspondence information 301 and 322 may not be RDB. The correspondence information 301 and the correspondence information 322 may be merged and managed using the destination in the correspondence information 322 as a key.

Next, the operation of the distribution system according to the fifth embodiment will be explained. Note that the same elements as in the configuration (or process) shown in FIGS. 1, 3, 4, 6, and 9A are designated by the same reference numerals, and the explanation thereof will be omitted as appropriate.

First, the flow of collecting the remaining capacity information of the protected area 330 of the memory 33 in the computer cluster is the same as the process shown in FIG. 3, so the explanation will be omitted.

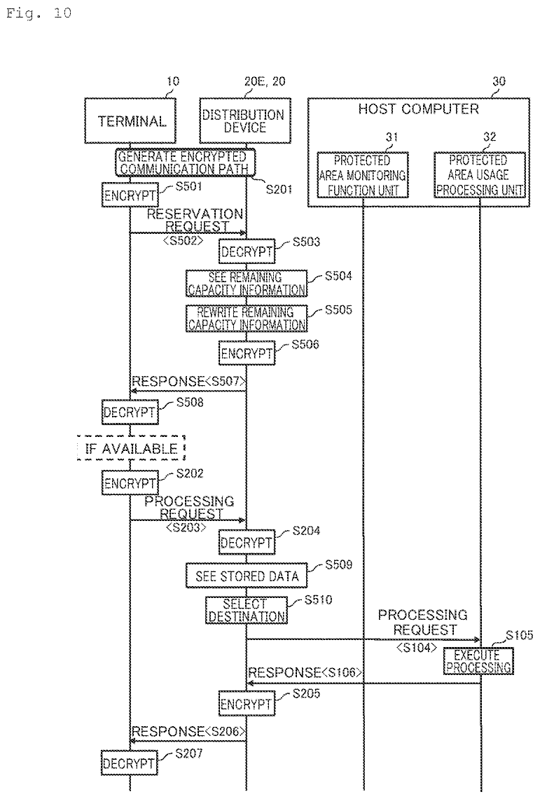

Next, the flow of processing when sending a reservation request before sending a processing request from the terminal 10 to the distribution device 20E will be described with reference to FIG. 10 (see FIGS. 1, 4, 6, and 9A as appropriate). The process of step S201 shown in FIG. 10 is the same as the process shown in FIG. 6, so the explanation thereof will be omitted. Following step S201, the terminal 10 encrypts the content of the reservation request using the session key A (step S501). Then, the terminal 10 transmits the encrypted reservation request to the distribution device 20E (step S502). Note that gRPC, REST API, XML-RPC, or the like may be used as a method for transmitting the reservation request.

Then, the distribution device 20E decrypts the content of the encrypted reservation request using the session key A (step S503). In this way, the distribution device 20E can grasp that the content of the received encrypted data is the required capacity information of the protected area and a reservation request for the protected area usage processing. In response to the reservation request, the distribution device 20E refers to the remaining capacity information of each of the plurality of hosts 30 stored in the storage unit 24 (step S504). Here, the destination selection unit 22E refers to the correspondence information 301 (FIG. 9B), for example, and determines availability based on the remaining capacity information.

If there is a host that can store the capacity required for the protected area usage processing, the destination selection unit 22E rewrites the remaining capacity information to a value obtained by subtracting the required capacity of the protected area from the remaining capacity of the protected area stored, for example, in the corresponding record of the correspondence information 301 (FIG. 9B) (step S505). At this time, the destination selection unit 22E rewrites the stored value of the investigation time to the current time in the corresponding record of the correspondence information 301 (FIG. 9B). Further, the distribution device 20E creates a response indicating that it is available and the reservation is completed.

On the other hand, if there is no host that can store the required capacity, the distribution device 20E creates a response indicating that it is unavailable.

Then, the distribution device 20E encrypts the content of the response using the session key A (step S506), and transmits the encrypted response to the terminal 10 (step S507). The requesting terminal 10 receives the encrypted response. Then, the terminal 10 decrypts the content of the response using the session key A (step S508), and can acquire a response to the reservation request.

If the protected area usage processing is available and the reservation is completed, the flow of processing in which the distribution device 20E allocates a processing request thereafter is similar to the operation of the distribution device 20B of the second embodiment. However, the distribution device 20E checks the reservation status depending on the reception timing and the requester of the received processing request. Specifically, first, the processes from step S202 to step S204 shown in FIG. 10 are the same as the processes shown in FIG. 6. In step S204, the distribution device 20E decrypts the encrypted content of the processing request using the session key A, and grasps the content of the received processing request. Then, the distribution device 20E refers to the data stored in the storage unit 24 (step S509), compares the communication destination information of the requester of the received processing request with the stored data, and selects a destination to which the processing request is to be transferred according to the comparison result (step S510). The processes of step S509 and step S510 may involve different reference data and destination determination methods, as in the following two cases, for example.

In the first case, the distribution device 20E refers to the data (correspondence information 322: FIG. 9C) that manages the reservation status stored in the storage unit 24. Then, the distribution device 20E compares the requester communication destination information with the data (correspondence information 322: FIG. 9C) managing the reservation status. If there is a record in which the status is “reservation” and which has the same IP address and port as those of the requester, the distribution device 20E allocates the processing request to the reserved host's IP address.

On the other hand, as a result of the above-mentioned comparison, if there is no record in which the status is “reservation” and which has the same IP address and port as those of the requester, in the second case, the distribution device 20E further refers to the data (correspondence information 301: FIG. 9B) managing the remaining capacity of the protected area stored in the storage unit 24. Then, the distribution device 20E selects the host 30 with a large remaining capacity of the protected area 330 as the destination. However, when processing requests from the same requester are received consecutively within a certain period of time, the distribution device 20E allocates the next processing request from the same requester to the host 30 to which the processing request was initially allocated.

Note that the processes from step S104 to step S106 and step S205 to step S207 shown in FIG. 10 are the same as the processes shown in FIG. 6, so the explanation thereof will be omitted.

### Sixth Embodiment

In the sixth embodiment, capacity information required for protected area usage processing is transmitted from the terminal to the distribution device at the same time as the processing request.

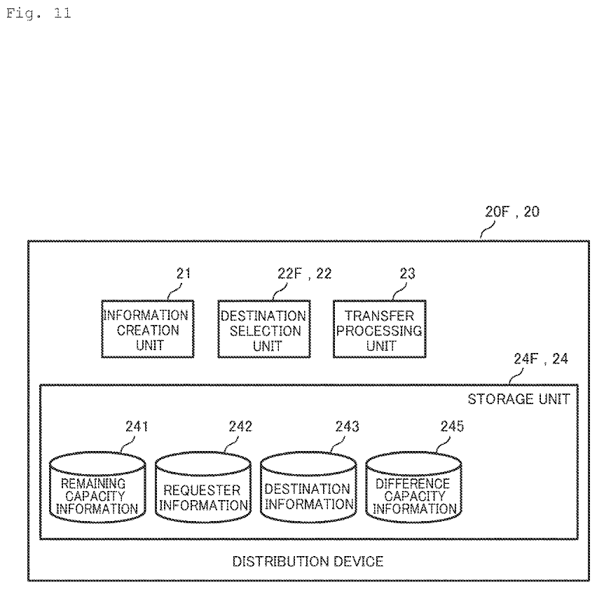

As shown in FIG. 11, the distribution device 20F according to the sixth embodiment includes an information creation unit 21, a destination selection unit 22F, a transfer processing unit 23, and a storage unit 24F. Note that the same elements as in the configuration shown in FIG. 2A are denoted by the same reference numerals, and the explanation thereof will be omitted, and the differences from the distribution device 20 shown in FIG. 2A will be explained.

The destination selection unit 22F is similar to the destination selection unit 22 shown in FIG. 2A in that it selects the host 30 with a large remaining capacity of the stored protected area 330 as the destination to which the processing request is distributed. However, the destination selection unit 22F differs from the destination selection unit 22 shown in FIG. 2A in that it narrows down available hosts based on the received necessary capacity information. The destination selection unit 22F subtracts the capacity information included in the processing request from the remaining capacity information stored for the plurality of hosts 30, and calculates the difference capacity information.

As shown in FIG. 11, the storage unit 24F stores remaining capacity information 241, requester information 242, destination information 243, and difference capacity information 245. The difference capacity information 245 schematically shows the difference information between the protected area remaining capacity stored for each host 30 and the capacity required for protected area usage processing.

Next, the operation of the distribution system according to the sixth embodiment will be explained. Note that the same elements as in the configuration (or process) shown in FIGS. 1, 3, and 4 are designated by the same reference numerals, and the explanation thereof will be omitted as appropriate First, the flow of collecting the remaining capacity information of the protected area 330 of the memory 33 in the computer cluster is the same as the process shown in FIG. 3, so the explanation will be omitted.

Next, the flow of processing in which the distribution device 20F allocates processing requests will be described with reference to FIG. 4 (see FIGS. 1 and 11 as appropriate). First, one of the plurality of terminals 10 transmits a processing request to the distribution device 20F requesting execution of the protected area usage processing (step S101). However, in the present embodiment, the processing request includes capacity information of the protected area required for the protected area usage processing as a parameter. Upon receiving the processing request, the distribution device 20F refers to the remaining capacity information of each of the plurality of hosts 30 stored in the storage unit 24F (step S102). Then, the destination selection unit 22F selects the host 30 with a large remaining capacity of the protected area 330 as the destination, taking the necessary capacity information of the protected area included in the parameters of the processing request into consideration (step S103). Then, the distribution device 20F transfers the processing request to the IP address selected as the destination (step S104).

However, in the present embodiment, in step S103, the destination selection unit 22F narrows down available hosts based on the required capacity information.

The destination selection unit 22F selects the host 30 with the smaller difference (difference capacity information) between (remaining capacity of the protected area)—(required capacity of the protected area) as the destination. At this time, it is not essential that the host 30 with the smallest difference capacity information be selected as the destination. In addition, a lower limit allowable value may be set, and the host 30 that has the remaining capacity of the protected area 330 corresponding to the smallest difference capacity information among several pieces of difference capacity information that are equal to or greater than this allowable value may be selected as the destination. The allowable value may be, for example, a percentage with respect to the total capacity of the protected area 330 of the host 30 (for example, 1% of the total capacity). Further, the allowable value may be a fixed value (such as 200 MB). By doing so, the allocated host 30 can execute the protected area usage processing with ample time. However, when processing requests from the same requester are received consecutively within a certain period of time, the destination selection unit 22F allocates the next request from the same requester to the host 30 to which the processing request was initially allocated.

### Seventh Embodiment

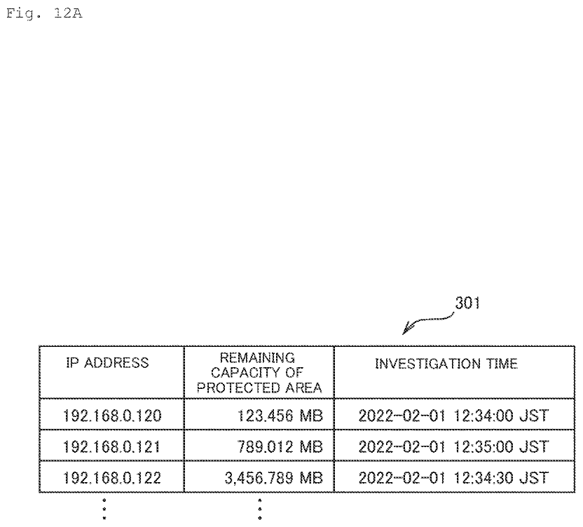

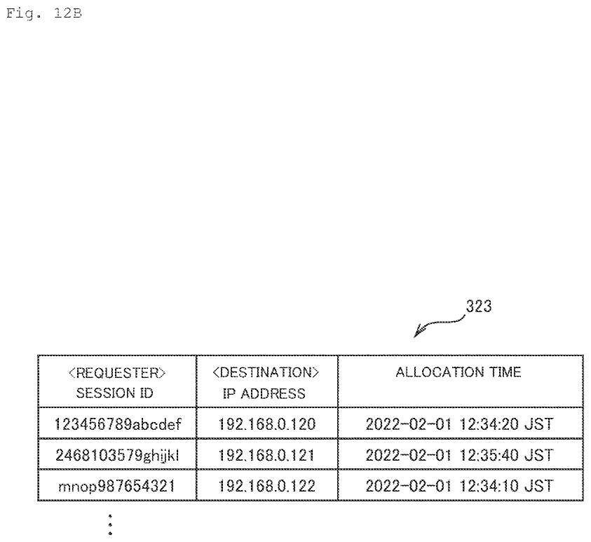

Next, a distribution device (hereinafter referred to as distribution device 20G) according to a seventh embodiment will be explained. The configuration of the distribution device 20G is similar to the configuration of the distribution device 20 shown in FIG. 2A. Hereinafter, differences from the distribution device 20 according to the first embodiment will be explained with reference to FIGS. 12A and 12B (see FIGS. 1, 2A, 2B, and 2C as appropriate).

The distribution device 20G stores correspondence information 301 shown in FIG. 12A in the storage unit 24 in an updatable manner. This correspondence information 301 is similar to the correspondence information 301 shown in FIG. 2B.

The distribution device 20G stores correspondence information 323 shown in FIG. 12B in the storage unit 24 in an updatable manner. The correspondence information 323 has requester information and destination information as table items. The correspondence information 323 differs in requester information from the correspondence information 321 shown in FIG. 2C.

The stored requester information is the session ID. The distribution device 20G generates a session ID for distinguishing the requester of the processing request, and stores it together with the IP address of the destination to which it is allocated and the time of allocation. The method of generating the session ID is not limited. For example, the distribution device 20G may generate a random value based on the IP address and port of the requester, the current time, and the like. The distribution device 20G generates a new session ID so that it does not have the same value as the session ID already held in the storage unit 24. Although it depends on the session ID generation method, if the same session ID indicating the same requester is stored in the storage unit 24, the distribution device 20G updates time information such as the allocation time.

The data structure of the correspondence information 323 is not limited to the illustrated column structure. The data structure of the correspondence information 323 may not be RDB. The correspondence information 301 and the correspondence information 323 may be merged and managed using the destination in the correspondence information 323 as a key.

The operation of the distribution system according to the seventh embodiment is similar to that of the first embodiment. The distribution device 20G normally selects the host 30 with a large remaining capacity of the protected area 330 (step S103), and transfers the processing request to the selected IP address (step S104). However, when processing requests from the same requester are received consecutively within a certain period of time, the distribution device 20G will allocate the next processing request from the same requester to the host 30 to which the processing request was initially allocated. The same requester here refers to the terminals 10 with the same session ID.

### Eighth Embodiment

Next, a distribution device (hereinafter referred to as distribution device 20H) according to the eighth embodiment will be explained. The configuration of the distribution device 20H is similar to the configuration of the distribution device 20 shown in FIG. 2A.

Next, the differences between the distribution device 20H and the distribution device 20 according to the first embodiment will be explained with reference to FIG. 3 (see FIGS. 1 and 2A as appropriate).

When collecting the remaining capacity information of the protected area 330 of the memory 33 in the computer cluster, the distribution device 20H acquires not only the remaining capacity information of the protected area but also other data. Other data is data representing the status of the host 30, such as the CPU usage rate. For example, in the host 30A, the protected area monitoring function unit 31A requests the protected area usage processing unit 32A to acquire the CPU usage rate and the remaining capacity information of the protected area 330A in the memory 33A (step S1). The protected area usage processing unit 32A outputs the remaining capacity information and the CPU usage rate in response to the acquisition request (step S2). Then, the host 30A notifies the distribution device 20H of the remaining capacity information and CPU usage rate acquired by the protected area monitoring function unit 31A and the transmission destination to the host 30A (step S3).

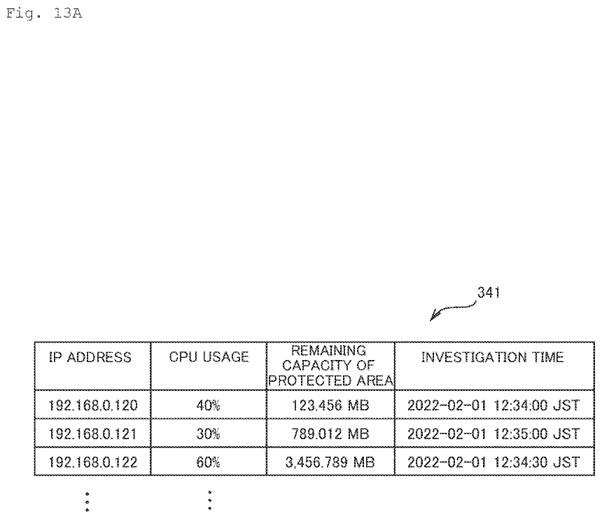

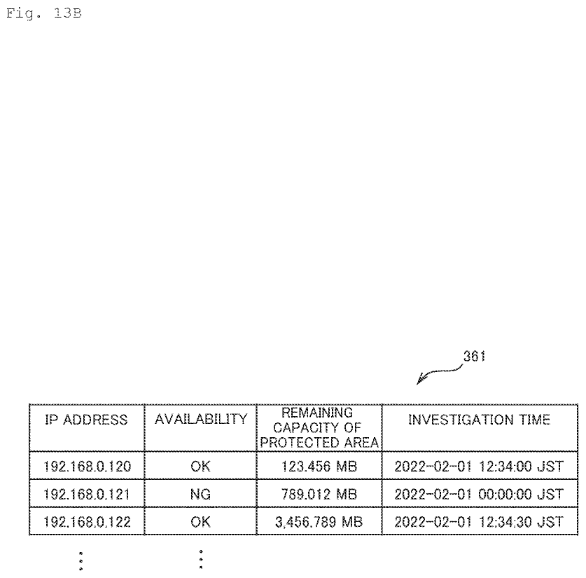

Then, the distribution device 20H stores the remaining capacity information of the protected area 330 and the CPU usage rate received from the host 30A in the storage unit 24 (step S4). FIG. 13A is a diagram illustrating an example of data that manages the remaining capacity of the protected area stored in the storage unit 24 of the distribution device 20H. The correspondence information 341 shown in FIG. 13A differs from correspondence information 301 shown in FIG. 2B in that it has CPU usage rate as a table item.

The data that the distribution device 20H acquires from the host 30 together with the remaining capacity information of the protected area 330 is not limited to the CPU usage rate. The data acquired together with the remaining capacity information of the protected area 330 may be, for example, the total remaining capacity of the memory area of the host 30.

Further, the data that the distribution device 20H acquires together with the remaining capacity information of the protected area 330 may be, for example, information on whether or not the protected area usage processing is available. To this end, the protected area monitoring function unit 31 of the host 30 may determine whether or not the protected area usage processing is available based on the data acquired from the protected area usage processing unit 32, and deliver the determination result to the distribution device 20H. For example, by making it possible to set in the protected area monitoring function unit 31 that if the CPU usage rate is 50% or more, the protected area usage processing is not available (NG), it is possible to determine whether or not the protected area usage processing is available based on the CPU usage rate.

FIG. 13B is a diagram illustrating an example of data that manages the remaining capacity of the protected area stored in the storage unit 24 of the distribution device 20H. The correspondence information 361 shown in FIG. 13B differs from the correspondence information 301 shown in FIG. 2B in that it has availability as a table item.

Next, the differences between the distribution device 20H and the distribution device 20 according to the first embodiment will be explained with reference to FIG. 4 (see FIGS. 1 and 2A as appropriate).

When allocating a processing request, the distribution device 20H may refer to the correspondence information 341 shown in FIG. 13A (step S102) and select the host 30 based on the remaining capacity information of the protected area 330 and the CPU usage rate (step S103). In this case, for example, the distribution device 20H can select a host with the largest remaining capacity of the protected area 330 among the hosts 30 whose CPU usage rate is less than 50%.

Furthermore, when allocating a processing request, the distribution device 20H may refer to the correspondence information 361 shown in FIG. 13B (step S102) and select the host 30 based on the remaining capacity information of the protected area 330 and the availability of the protected area usage processing (step S103). In this case, for example, the distribution device 20H can select a host with the largest remaining capacity of the protected area 330 among the hosts 30 that can use the protected area usage processing.

### Ninth Embodiment

In the ninth embodiment, similarly to the sixth embodiment, capacity information required for protected area usage processing is transmitted from the terminal to the distribution device at the same time as the processing request. Therefore, the processing request includes the capacity information of the protected area required for the protected area usage processing as a parameter.

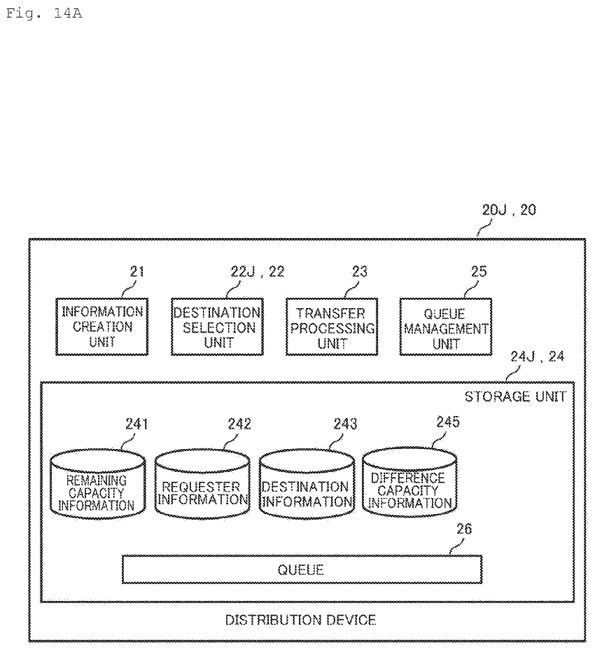

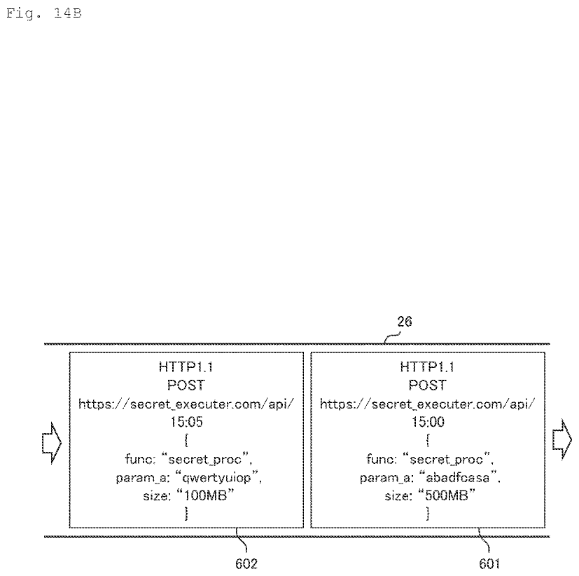

As shown in FIG. 14A, the distribution device 20J includes an information creation unit 21, a destination selection unit 22J, a transfer processing unit 23, a storage unit 24J, and a queue management unit 25. Note that the same elements as in the configuration shown in FIG. 11 are designated by the same reference numerals, and the explanation thereof will be omitted, and differences from the distribution device 20F shown in FIG. 11 will be described.

The destination selection unit 22J is similar to the destination selection unit 22F shown in FIG. 11 in that it narrows down available hosts based on the received required capacity information. However, the destination selection unit 22J differs from the destination selection unit 22F shown in FIG. 11 in that it selects a destination based on information received from the queue management unit 25.

The storage unit 24J differs from the storage unit 24F shown in FIG. 11 in that it includes a queue 26, as shown in FIG. 14A. The queue 26 schematically shows the data structure stored in the storage unit 24J. The storage unit 24J can store the correspondence information 301 shown in FIG. 2B and the correspondence information 321 shown in FIG. 2C. Note that the correspondence information 341 shown in FIG. 13A and the correspondence information 361 shown in FIG. 13B can also be stored.

The queue management unit 25 outputs processing requests to the queue 26 and manages information on a first-in-first-out basis, and processes the oldest processing request among the processing requests that have not been executed. Among the processing requests that have not been executed, the oldest one is the processing request stored at the head of the queue 26. FIG. 14B is a diagram schematically showing processing requests stored in the queue 26. A processing request 601 includes the time information of 15:00 as a message content, the capacity information of 500 MB required for the protected area usage processing, and the like as one of the parameters. Similarly, a processing request 602 includes the time information of 15:05, the capacity information of 100 MB required for protected area usage processing, and the like. The processing request 601 is stored at the head of the queue 26, and the processing request 602 is processed next to the processing request 601.

The queue management unit 25 outputs processing requests to the queue 26 and manages the processing request stored at the head of the queue 26 based on the capacity information included in the processing request stored at the head of the queue 26. The queue management unit 25 calculates difference capacity information obtained by subtracting the capacity information included in the processing request stored at the head of the queue 26 from the remaining capacity information (for example, correspondence information 301) stored for the plurality of hosts 30. Although the difference capacity information is actually calculated for the number of hosts 30, it is schematically shown as one difference capacity information 245 in FIG. 14A.

If the difference capacity information is equal to or greater than a predetermined value, the queue management unit 25 notifies the destination selection unit 22J of the processing request stored at the head of the queue 26 together with the information of the host 30 when the difference capacity information is equal to or greater than the predetermined value and the smallest difference capacity information was calculated. On the other hand, if the difference capacity information is smaller than the predetermined value, the queue management unit 25 continues to monitor the processing request stored at the head of the queue 26 without outputting it. This predetermined value is similar to the above-mentioned allowable value, and may be, for example, a percentage with respect to the total capacity of the protected area 330 of the host 30 (for example, 1% of the total capacity), or a fixed value (for example, 200 MB).

Next, the operation of the distribution system according to the ninth embodiment will be explained. Note that the same elements as in the configuration (or process) shown in FIGS. 1, 3, and 4 are designated by the same reference numerals, and the explanation thereof will be omitted as appropriate. First, the flow of collecting the remaining capacity information of the protected area 330 of the memory 33 in the computer cluster is the same as the process shown in FIG. 3, so the explanation will be omitted.

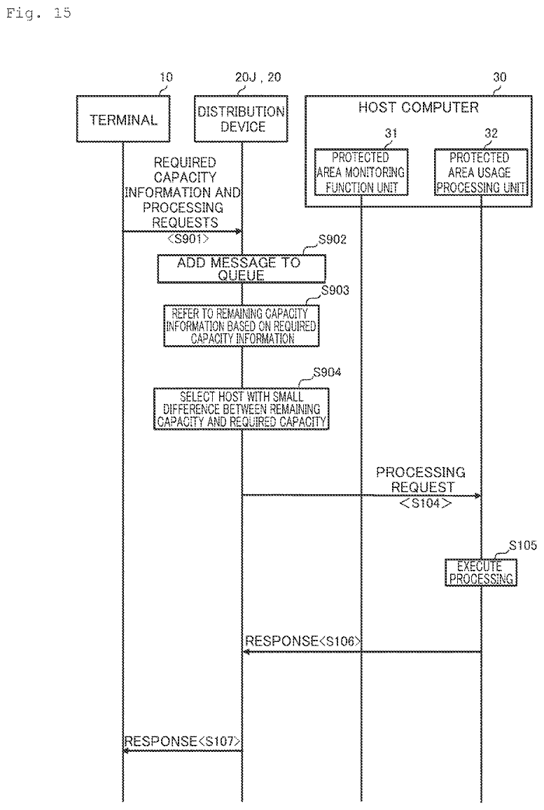

Next, the flow of processing in which the distribution device 20J allocates processing requests will be described with reference to FIG. 15 (see FIGS. 1 and 14A as appropriate). First, one of the plurality of terminals 10 transmits capacity information of the protected area (required capacity information) required for protected area usage processing and a processing request to the distribution device 20J (step S901). Upon receiving the processing request, the distribution device 20J adds the processing request message to the processing request waiting queue (step S902) and holds it.

Then, the queue management unit 25 refers to data (for example, correspondence information 301: FIG. 2B) that manages the remaining capacity of the protected area based on the required capacity information in the parameter information of the processing request that is first added to the queue (step S903). The queue management unit 25 calculates difference capacity information obtained by subtracting the required capacity information from the remaining capacity information stored for each host 30. If it is determined that there is no host 30 for which the required capacity is allowable, the queue management unit 25 monitors the stored remaining capacity of the protected area without outputting the processing request stored at the head of the queue 26 and continues monitoring until the capacity required for the process becomes allowable.

On the other hand, the queue management unit 25 delivers information on the host 30 that has small difference capacity information and is determined to be allowable to the destination selection unit 22J together with a processing request. The destination selection unit 22J selects a host with a small difference between the remaining capacity and the required capacity of the protected area 330 as the destination (step S904). In this way, if there is a host 30 that is allowable, the distribution device 20J sends a processing request to the selected IP address (step S104). In this way, since the distribution device 20J has the queue 26, it is possible to execute processing requests from the terminal 10 in order without returning a response indicating that they cannot be executed.

It should be noted that the processes of steps S105 to S107 shown in FIG. 15 are the same as the processes shown in FIG. 4, so the explanation thereof will be omitted.

### Hardware Configuration

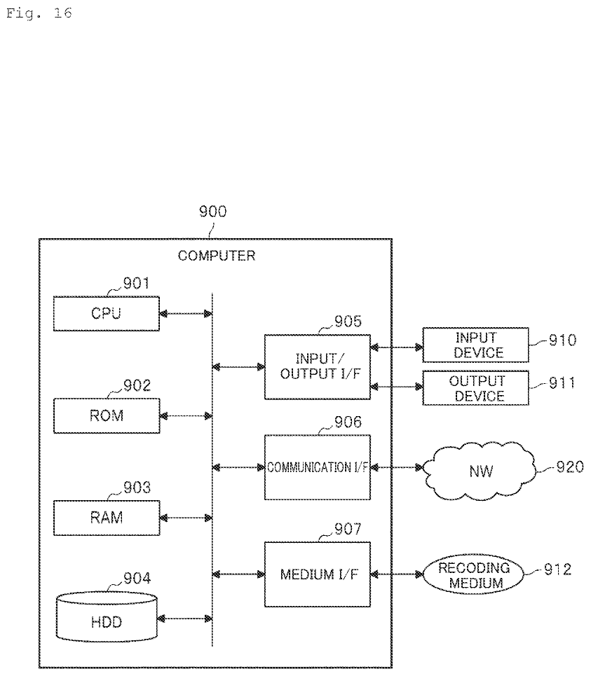

The distribution device 20 according to the embodiment is realized, for example, by a computer 900 configured as shown in FIG. 16. FIG. 16 is a hardware configuration diagram showing an example of the computer 900 that implements the functions of the distribution device 20 according to the present embodiment. The computer 900 includes a central processing unit (CPU) 901, a read only memory (ROM) 902, a random access memory (RAM) 903, a hard disk drive (HDD) 904, an input/output interface (I/F) 905, a communication I/F 906, and a medium I/F 907.

The CPU 901 operates based on a program stored in the ROM 902 or the HDD 904. The ROM 902 stores a boot program executed by the CPU 901 when the computer 900 is started, a program related to the hardware of the computer 900, and the like.

The CPU 901 controls an input device 910 such as a mouse and a keyboard, and an output device 911 such as a display and a printer through the input/output I/F 905. The CPU 901 acquires data from the input device 910 through the input/output I/F 905 and outputs the generated data to the output device 911. Note that a graphics processing unit (GPU) or the like may be used as a processor together with the CPU 901.

The HDD 904 stores a program executed by the CPU 901, data used by the program, and the like. The communication I/F 906 receives data from another device via a communication network 920, outputs the data to the CPU 901, and transmits data generated by the CPU 901 to other devices via the communication network 920.

The medium I/F 907 reads a program or data stored in recording medium 912 and outputs it to the CPU 901 through the RAM 903. The CPU 901 loads a program related to desired processing from the recording medium 912 onto the RAM 903 through the medium I/F 907, and executes the loaded program. The recording medium 912 is an optical recording medium such as a digital versatile disc (DVD) or a phase change rewritable disk (PD), a magneto- optical recording medium such as a magneto optical disk (MO), a magnetic recording medium, a semiconductor memory, or the like.

For example, when the computer 900 functions as the distribution device 20 according to the embodiment, the CPU 901 implements the functions of the distribution device 20 by executing a program loaded onto the RAM 903. Further, data in the RAM 903 is stored in the HDD 904. The CPU 901 reads a program related to target processing from the recording medium 912 and executes the program. In addition, the CPU 901 may read a program related to the object processing from another device via the communication network 920.

### Effect

As described above, the distribution device includes the storage unit 24; the information creation unit 21 that stores, in the storage unit 24, remaining capacity information of a protected area received from each of a plurality of host computers 30 forming a computer cluster; the destination selection unit 22 that, each time a processing request is received from one of a plurality of terminals 10, requesting execution of processing using an encrypted protected area 330 on the memory 33 of the host computer 30, refers to the remaining capacity information of each of the plurality of host computers 30 stored in the storage unit 24 in accordance with the processing request to select a destination to which the processing request is to be distributed; and the transfer processing unit 23 that transfers the processing request to the destination and transfers a response according to the processing request received from the destination to a requesting terminal 10.

By doing this, each time the distribution device receives a processing request, the distribution device distributes the processing request according to the remaining capacity information of the protected area for each of the plurality of host computers. Therefore, by distributing processing requests to host computers with a large amount of remaining capacity of the protected area, it is possible to suppress depletion of the protected area of the memory for the entire computer cluster. Therefore, the distribution device can prevent an increase in error responses and a decrease in response time of a service that uses a computer cluster composed of computers each having an encrypted protected area on memory.

In the distribution device, the information creation unit 21 stores communication destination information of the host computer 30 together with the remaining capacity information of the protected area in the storage unit 24, and the destination selection unit 22 stores communication destination information of a destination to which the processing request is to be distributed as well as communication destination information of a terminal 10 that has requested the processing request in the storage unit 24.

By doing so, in the distribution device, the transfer processing unit 23 can transfer the processing request to the destination based on the communication destination information of the host computer 30 stored in the storage unit 24. Further, in the distribution device, the transfer processing unit 23 can transfer a response according to the processing request to the requesting terminal 10 based on the correspondence information 321 between the destination to which the processing request is to be distributed and the requester.

In the distribution device, when a usage request which includes the capacity information of the protected area required for the protected area usage processing and requests confirmation of whether or not the protected area usage processing can be used is received from the terminal 10 prior to the processing request, the destination selection unit 22 determines availability based on remaining capacity information of each of a plurality of host computers 30 stored in the storage unit 24.

By doing this, in the distribution device, the destination selection unit 22 can determine in advance whether protected area usage processing is available by comparing the capacity information of the protected area required for the protected area usage processing with the remaining capacity information stored in the storage unit 24. Therefore, the distribution device distributes the processing requests that can use the protected area usage processing, so that the allocated computers can suppress the depletion of the protected area of memory.

In the distribution device, when a reservation request is received from the terminal 10 prior to the processing request, which includes the capacity information of the protected area required for the protected area usage processing and requests a reservation of the protected area usage processing, and when it is determined that the protected area usage processing is available, the destination selection unit 22E rewrites the stored remaining capacity information by subtracting the capacity information required for the protected area usage processing from the remaining capacity information stored for the host computer 30 determined to be available.

By doing so, in the distribution device, the information creation unit 21 updates the remaining capacity information of the protected area of the host computer 30 and stores it in the storage unit 24 each time it receives the remaining capacity information of the protected area of the host computer 30. Further, the destination selection unit 22E updates the remaining capacity information stored in the storage unit 24 in accordance with the reservation of a processing request that can use the protected area usage processing. Therefore, the distribution device can always store the accurate remaining capacity information in the storage unit 12 at the time of receiving a processing request. Therefore, it is possible to prevent a processing request from being distributed to a host computer with insufficient remaining capacity of the protected area of the memory, and to suppress the depletion of the protected area of the memory.

In the distribution device, the processing request includes, as a parameter, capacity information of the protected area required for the protected area usage processing, the distribution device further includes the queue management unit 25 that outputs the processing request to a queue 26 and manages the processing request stored at the head of the queue 26 based on the capacity information included in the processing request stored at the head of the queue 26, and the queue management unit 25 is configured to: calculate difference capacity information obtained by subtracting the capacity information included in the processing request stored at the head of the queue 26 from each of the remaining capacity information stored for the plurality of host computers 30; if the difference capacity information is equal to or greater than a predetermined value, notify the destination selection unit 22J of the processing request stored at the head of the queue 26 together with the information of the host computer 30 when the difference capacity information is equal to or greater than the predetermined value and a smallest difference capacity information is calculated; and if the difference capacity information is smaller than the predetermined value, continue monitoring without outputting the processing request stored at the head of the queue 26.

By doing so, in the distribution device, the queue management unit 25 can notify the destination selection unit 22J of the information of the host computer 30 whose remaining capacity information has a small difference from the capacity information of the protected area required for processing. Therefore, depletion of the protected area of the memory can be suppressed by effectively using the protected area of the memory for the entire computer cluster. In addition, the queue management unit 25 can wait for the increase and recovery of the remaining amount of the protected area of the memory in each host computer 30 depending on the capacity information of the protected area required for processing, so that depletion of the protected area of the memory can be suppressed.

The distribution system includes the distribution device 20; and the plurality of host computers 30 forming a computer cluster, wherein the host computer 30 includes: the memory 33 having an encrypted protected area 330; the protected area monitoring function unit 31 that acquires remaining capacity information of the protected area 330 and notifies the distribution device 20 of the remaining capacity information together with communication destination information of the host computer 30; and the protected area usage processing unit 32 that executes protected area usage processing upon receiving the processing request from the distribution device 20, and transmits a response including a return value according to the protected area usage processing to the distribution device 20.

By doing so, in the distribution system, each time information on the remaining capacity of the protected area of the host computer 30 is received from the host computer 30, the distribution device 20 can update the remaining capacity information and store it in the storage unit 24. Therefore, the distribution device 20 can select an appropriate host computer based on the remaining capacity information of the memory 33 of each host computer 30 collected from the plurality of host computers 30 forming the computer cluster. Therefore, the distribution system can suppress depletion of the protected area of the memory for the entire computer cluster.

The distribution method is a distribution method of the distribution device 20, and the distribution device 20 includes the storage unit 24, the method including: storing, in the storage unit 24, remaining capacity information of a protected area received from each of a plurality of host computers 30 forming a computer cluster; each time a processing request is received from one of a plurality of terminals 10 requesting execution of processing using an encrypted protected area 330 on the memory 33 of the host computer 30, referring to the remaining capacity information of each of the plurality of host computers 30 stored in the storage unit 24 in accordance with the processing request to select a destination to which the processing request is to be distributed; transferring the processing request to the destination; and transferring a response according to the processing request received from the destination to a requesting terminal 10.

By doing this, in the distribution method, each time the distribution device 20 receives a processing request, the distribution device 20 distributes the processing request according to the remaining capacity information of the protected area for each of the plurality of host computers. Therefore, by distributing processing requests to host computers with a large amount of remaining capacity of the protected area, it is possible to suppress depletion of the protected area of the memory for the entire computer cluster. Therefore, the distribution method can prevent an increase in error responses and a decrease in response time of a service that uses a computer cluster composed of computers each having an encrypted protected area on memory.

Note that the present invention is not limited to the example described above, and various modification examples can be made by a person of ordinary skill in the art within the technical idea of the present invention.

For example, the IP address in the correspondence information 301 and the correspondence information 321 may be changed to hostname, for example, in an environment where name resolution is possible. Further, the IP address that serves as both the identifier and the communication destination of the host 30 may be replaced and stored with a set of another value that can identify the host 30 and another value that serves as the communication destination.

Furthermore, the sixth to ninth embodiments may be implemented in combination with other combinable embodiments.

### REFERENCE SIGNS LIST

1 Distribution system
10, 10A, 10B Terminal
20, 20B, 20C, 20D, 20E, 20F, 20J Distribution device
21 Information creation Unit
22, 22E, 22F, 22J Destination selection unit
23 Transfer processing unit
24, 24E, 24F, 24J Storage unit
241 Remaining capacity information of protected area
242 Requester information (communication destination information)
243 Destination information (communication destination information)
244 Reservation information
245 Difference capacity information
25 Queue management unit
26 Queue
30, 30A, 30B Host computer
31, 31A, 31B Protected area monitoring function unit
32, 32A, 32B Protected area usage processing unit
33, 33A, 33B Memory
330, 330A, 330B Protected area

1. A distribution device comprising:
a storage unit comprising a memory device;
an information creation unit, including one or more processors, configured to that store, in the storage unit, remaining capacity information of a protected area received from each of a plurality of host computers forming a computer cluster;
a destination selection unit that, including one or more processors, configured to, each time a processing request is received from one of a plurality of terminals, requesting execution of processing using the protected area on a memory of the host computer, refer to the remaining capacity information of each of the plurality of host computers stored in the storage unit in accordance with the processing request to select a destination to which the processing request is to be distributed; and
a transfer processing unit, including one or more processors, configured to transfer the processing request to the destination and transfer a response according to the processing request received from the destination to a requesting terminal.

2. The distribution device according to claim 1, wherein the information creation unit is configured to store communication destination information of the host computer together with the remaining capacity information of the protected area in the storage unit, and
the destination selection unit is configured to store communication destination information of a destination to which the processing request is to be distributed as well as communication destination information of the terminal that has requested the processing request in the storage unit.

3. The distribution device according to claim 1, wherein when a usage request which includes the capacity information of the protected area required for protected area usage processing and requests confirmation of whether or not the protected area usage processing can be used is received from the terminal prior to the processing request, the destination selection unit is configured to determine availability based on remaining capacity information of each of a plurality of host computers stored in the storage unit.

4. The distribution device according to claim 3, wherein when a reservation request is received from the terminal prior to the processing request, which includes the capacity information of the protected area required for the protected area usage processing and requests a reservation of the protected area usage processing, and when it is determined that the host computer is available, the destination selection unit is configured to rewrite the stored remaining capacity information by subtracting the capacity information required for the protected area usage processing from the remaining capacity information stored for the host computer determined to be available.

5. The distribution device according to claim 1, wherein the processing request includes, as a parameter, capacity information of the protected area required for protected area usage processing,
the distribution device further includes a queue management unit configured to output the processing request to a queue and manage the processing request stored at a head of the queue based on the capacity information included in the processing request stored at the head of the queue, and
the queue management unit is configured to:
calculate difference capacity information obtained by subtracting the capacity information included in the processing request stored at the head of the queue from each of the remaining capacity information stored for the plurality of host computers;
if the difference capacity information is equal to or greater than a predetermined value, notify the destination selection unit of the processing request stored at the head of the queue together with the information of the host computer when the difference capacity information is equal to or greater than the predetermined value and a smallest difference capacity information is calculated; and
if the difference capacity information is smaller than the predetermined value, continue monitoring without outputting the processing request stored at the head of the queue.

6. A distribution system comprising:
the distribution device according to claim 1; and
a plurality of host computers forming a computer cluster, wherein
the host computer includes:
a memory having an encrypted protected area;
a protected area monitoring function unit configured to acquire remaining capacity information of the encrypted protected area and notify the distribution device of the remaining capacity information together with communication destination information of the host computer; and
a protected area usage processing unit configured to execute protected area usage processing upon receiving the processing request from the distribution device, and transmit a response including a return value according to the protected area usage processing to the distribution device.

7. A distribution method of a distribution device including
a storage unit, the method comprising:
storing, in the storage unit, remaining capacity information of an encrypted protected area received from each of a plurality of host computers forming a computer cluster;
each time a processing request is received from one of a plurality of terminals requesting execution of processing using the encrypted protected area on a memory of the host computer, referring to the remaining capacity information of each of the plurality of host computers stored in the storage unit in accordance with the processing request to select a destination to which the processing request is to be distributed;
transferring the processing request to the destination; and
transferring a response according to the processing request received from the destination to a requesting terminal.

8. (canceled)
